(19) United States
(12) Patent Application Publication
(10) Pub. No.: US 2025/0154045 A1
(43) Pub. Date: May 15, 2025

(54) GLASS SLUMPING FIXTURE

(71) Applicant: Honeywell Federal Manufacturing & Technologies, LLC, Kansas City, MO (US)

(72) Inventors: Rachel Grodsky, Raymore, MO (US); James Colby, Independence, MO (US); Matthew Hodges, Lee's Summit, MO (US); Greg Nedell, Pleasant Hill, MO (US)

(21) Appl. No.: 18/508,679

(22) Filed: Nov. 14, 2023

(51) Int. Cl. C03B 23/025

(52) U.S. Cl. CPC C03B 23/0252; C03B 2225/02

(57) ABSTRACT

A glass slumping fixture comprises a structure including a first side surface, a spaced-apart second side surface, and a top surface positioned therebetween and connected to each side surface. The structure further includes spaced apart slots that are positioned on the first side surface, the second side surface, and the top surface, each slot being an indentation that extends along at least a portion of a height of the first side surface, at least a portion of a height of the second side surface, and across the top surface from the first side surface to the second side surface. The structure retains a glass sheet during a slumping process including the glass sheet being placed on the top surface over the slots and heated until a first portion of the glass sheet contacts the first side surface and a second portion of the glass sheet contacts the second side surface.

### FEDERALLY SPONSORED RESEARCH AND DEVELOPMENT

This invention was made with Government support under Contract No.: DE-NA0002839 awarded by the United States Department of Energy/National Nuclear Security Administration. The Government has certain rights in the invention.

### FIELD OF THE INVENTION

Embodiments of the current invention relate to glass slumping.

### BACKGROUND OF THE INVENTION

Glass slumping is a process that involves the heating of a generally planar sheet of glass over a mold, such that the glass softens or deforms and takes the shape of the mold. The glass is then cooled to form a part, which may have an artistic purpose or a functional use. Often, during the slumping process, air gets trapped between the sheet of glass and the contact surface of the mold. The trapped air causes bulges and roundness on surfaces and makes it difficult to achieve well-defined 90-degree edges or folds.

### SUMMARY OF THE INVENTION

Embodiments of the current invention address one or more of the above-mentioned problems and provide a distinct advance in the art of glass slumping that avoids the trapped air issues described above. Some embodiments of the current invention provide a glass slumping fixture that includes a plurality of slots on its slumping surface that allow air to escape as contact is made between the glass sheet and the slumping surface. Other embodiments of the current invention provide a glass slumping apparatus that includes a glass slumping fixture which retains the glass sheet and a slumping weight which is positioned on the surfaces of the glass sheet to be folded such that the slumping weight presses the glass sheet against the slumping surfaces of the fixture during the slumping process.

In some embodiments, the current invention provides a glass slumping fixture comprising a structure including a first side surface, a spaced-apart second side surface, and a top surface positioned therebetween and connected to each side surface. The structure further includes a plurality of slots spaced apart from one another and positioned on the first side surface, the second side surface, and the top surface, each slot being an indentation that extends along at least a portion of a height of the first side surface, at least a portion of a height of the second side surface, and across the top surface from the first side surface to the second side surface. The structure is configured to retain a glass sheet during a slumping process which includes the glass sheet being placed on the top surface over the slots and heated until a first portion of the glass sheet contacts the first side surface and a second portion of the glass sheet contacts the second side surface.

In other embodiments, the current invention provides a glass slumping apparatus comprising a glass slumping fixture and a slumping weight. The glass slumping fixture is configured to retain a glass sheet during a slumping process. The glass slumping fixture includes a first side surface, a spaced-apart second side surface, and a top surface positioned therebetween and connected to each side surface. The top surface is configured to receive the glass sheet. The glass slumping fixture further includes a first end wall connected to a first end of the top surface, and a second end wall connected to a second end of the top surface, with the first end wall and the second end wall each extending above the top surface. The slumping weight includes a first side wall, a second side wall, a first end wall, and a second end wall connected to one another to form a rectangular weight with an open center. The slumping weight is configured to be positioned on the glass sheet at the start of the slumping process and around a lower end of the glass slumping fixture at the end of the slumping process.

In yet other embodiments, the current invention provides a glass slumping apparatus comprising a glass slumping fixture and a glass holding fixture. The glass slumping fixture is configured to retain a glass sheet during a slumping process. The glass slumping fixture includes a bottom surface, a first angled surface, and a second angled surface connected to one another to form an isosceles triangle cross section. One of the angled surfaces is configured to receive the glass sheet. The glass slumping fixture further includes a first end surface and a spaced apart second end surface each connected to an opposing end of the bottom surface, the first angled surface, and the second angled surface. The glass holding fixture includes a multi-surface structure having a length roughly equivalent to a length of the glass slumping fixture. The glass holding fixture is configured to hold a portion of the glass sheet against one of the angled surfaces during the slumping process.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a side elevational view of a glass slumping fixture, constructed in accordance with various embodiments of the current invention, for forming right angle folds in a sheet of glass;

FIG. 1A is an enlarged view of a portion of the glass slumping fixture illustrating a glass mold that includes a plurality of slots;

FIG. 1B is a side elevational view of the glass slumping fixture including a plurality of slots oriented in a horizontal fashion;

FIG. 1C is a top plan view of the glass slumping fixture including the horizontal slots;

FIG. 1D is a cross-sectional view of the glass slumping fixture cut along the line 1D-1D of FIG. 1C;

FIG. 1E is a side elevational view of the glass slumping fixture including a plurality of slots oriented in a diagonal fashion;

FIG. 2A is an end elevational view of one embodiment of the glass slumping fixture that includes 90-degree interior angles between side surfaces and a top surface;

FIG. 2B is an end elevational view of another embodiment of the glass slumping fixture that includes greater than 90-degree interior angles between side surfaces and the top surface;

FIG. 3 is an upper perspective view of the glass slumping fixture illustrating a glass sheet prepared to be placed on one of the glass molds;

FIG. 4 is an upper perspective view of the glass slumping fixture illustrating the glass sheet positioned on one of the glass molds at the start of a glass slumping process;

FIG. 5 is an upper perspective view of the glass slumping fixture illustrating that a glass part has been formed at the end of a glass slumping process;

FIG. 6 is an upper perspective view of the glass part;

FIG. 7 is a side elevational view of a variation or alternative of glass slumping fixture of FIG. 1, the glass slumping fixture coupled to a vacuum source;

FIG. 8 is an upper perspective view of a glass slumping apparatus, constructed in accordance with other embodiments of the current invention, comprising a glass slumping fixture, a slumping weight, and a glass positioning fixture;

FIG. 9 is an upper perspective view of the glass slumping apparatus retaining a glass sheet on a glass mold;

FIG. 10 is an upper perspective view of the glass slumping apparatus further including a slumping weight positioned on the glass sheet at the start of a glass slumping process;

FIG. 11 is an upper perspective view of the glass slumping apparatus with the slumping weight positioned around a lower edge of the glass slumping fixture at the end of the glass slumping process;

FIG. 12 is an end elevational view of a glass slumping apparatus, constructed in accordance with yet other embodiments of the current invention, comprising a glass slumping fixture and a glass holding fixture;

FIG. 13 is an upper perspective view of the glass slumping apparatus;

FIG. 14 is an upper perspective view of the glass slumping apparatus retaining a glass sheet and the glass holding fixture holding the glass sheet at the start of a glass slumping process;

FIG. 15 is an upper perspective view of a glass part formed by the glass slumping apparatus of FIG. 12.

FIG. 16 is an upper perspective view of a glass slumping fixture, constructed in accordance with yet other embodiments of the current invention, the glass slumping fixture including a curvature shape;

FIG. 17 is an upper perspective view of a glass part formed by the glass slumping apparatus of FIG. 16;

FIG. 18 is an upper perspective view of a glass slumping fixture, constructed in accordance with yet other embodiments of the current invention, the glass slumping fixture including a rounded shape; and

FIG. 19 is an upper perspective view of a glass part formed by the glass slumping apparatus of FIG. 18.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

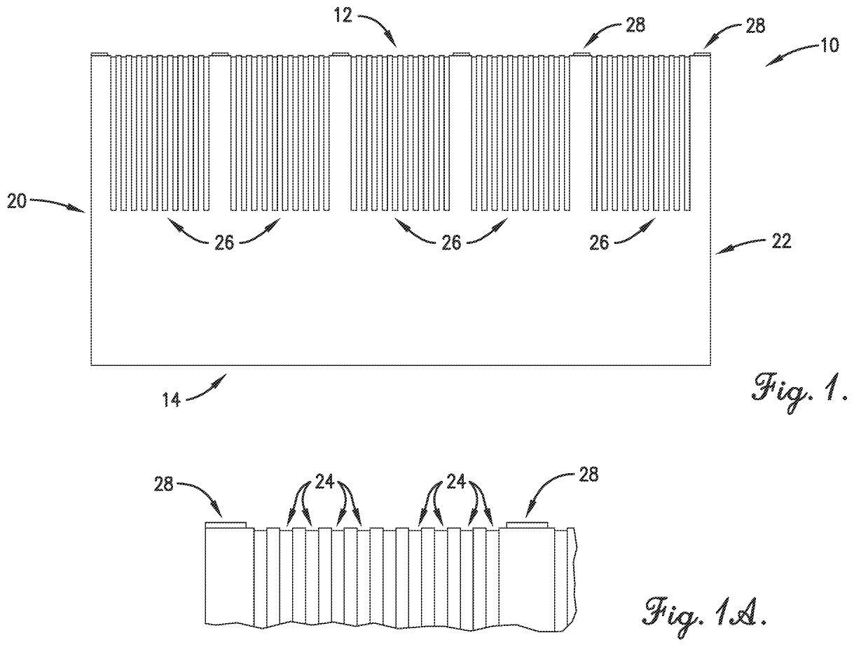

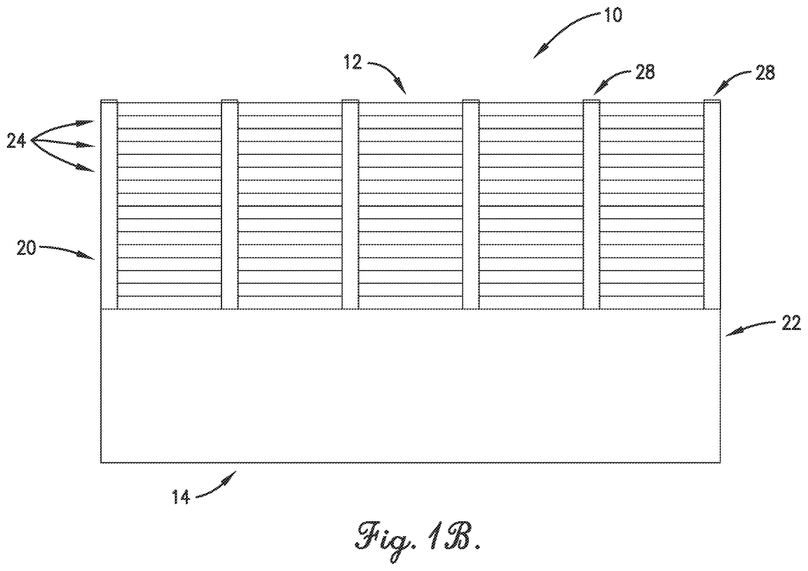

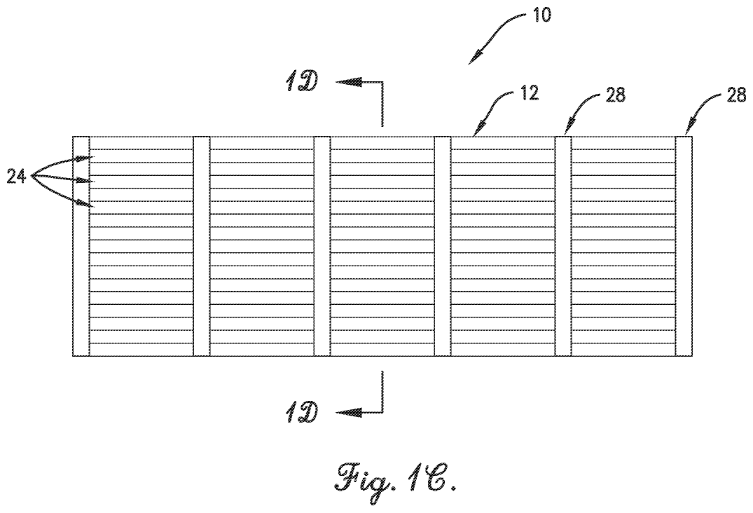

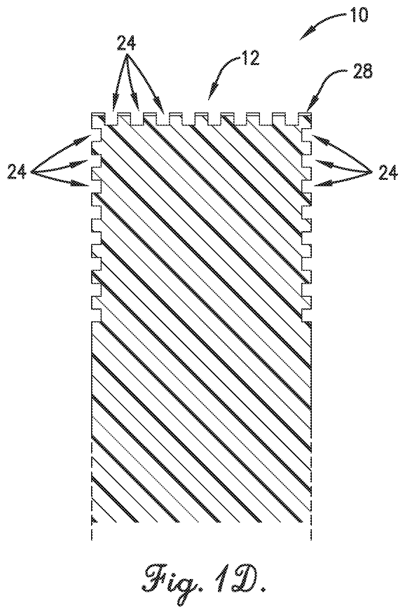

A glass slumping fixture 10, constructed in accordance with at least a first embodiment of the current invention, is shown in FIGS. 1-5. The glass slumping fixture 10 is utilized to form a glass sheet 100 into a glass part 102, shown in FIG. 6, having two or more sections or segments, with a roughly orthogonal (90-degree) angle between each section, although other angle values are possible. The glass sheet 100 may include types of sheet glass, flat glass, or plate glass that have nearly any composition. Exemplary glass sheets 100 may have a higher magnesium oxide and sodium oxide content than container glass, and a lower silica, calcium oxide, and aluminum oxide content. In addition, the glass sheet 100 may be formed from the five standard glass formers-silica, phosphate, borosilicate, chalcogenide and germanium.

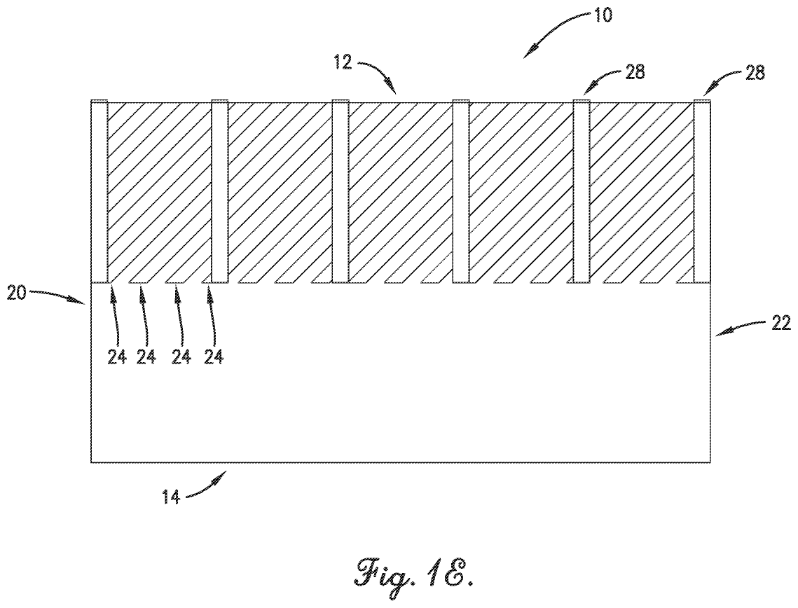

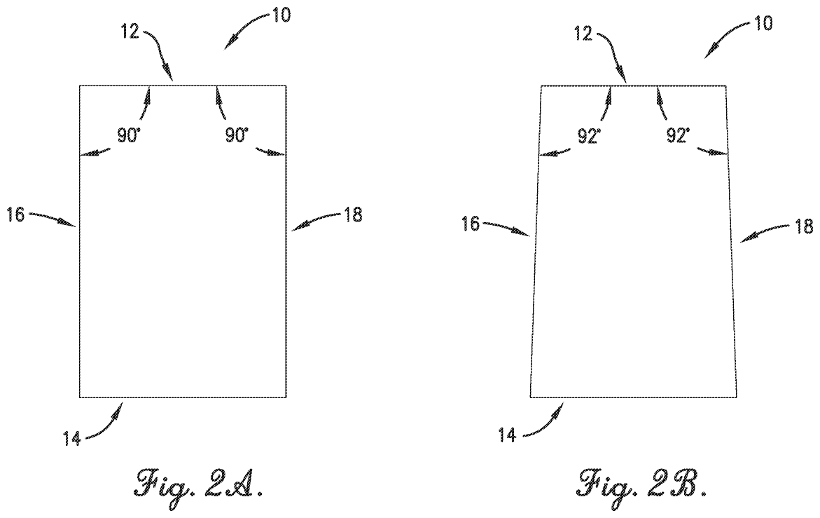

The glass slumping fixture 10 broadly comprises a top surface 12, a bottom surface 14, a first side surface 16, a second side surface 18, a first end surface 20, and a second end surface 22 connected to one another appropriately to form a generally rectangular box shape. In some embodiments, the glass slumping fixture 10 is generally solid. In other embodiments, the glass slumping fixture 10 may include a cavity or may be hollow, such that the glass slumping fixture 10 includes six walls, an outer surface of each forming the previously-listed surfaces. In some embodiments as shown in FIG. 2A, the top surface 12 may connect to each of the first side surface 16 and the second side surface 18 with an interior angle that is approximately 90 degrees. In other embodiments, the top surface 12 may connect to each of the first side surface 16 and the second side surface 18 with an interior angle that is greater than 90 degrees. For example, as shown in FIG. 2B, the top surface 12 may connect to each of the first side surface 16 and the second side surface 18 having an interior angle that is approximately 92 degrees.

The glass slumping fixture 10 is typically formed from material that can withstand the temperature required to melt the glass sheets 100, such that the glass slumping fixture 10 will not deform or melt while the glass part 102 is being formed. In addition, it is desirable that the material of the glass slumping fixture 10 have a coefficient of thermal expansion (CTE) that is similar to a CTE of the glass sheets 100. Or more generally, the glass slumping fixture 10 may have a relatively low CTE. Exemplary materials for the glass slumping fixture 10 include ceramics, stainless steel, or non-reactive metals with a low CTE and a high melting temperature.

The glass slumping fixture 10 further includes a plurality of slots 24, shown in more detail in FIG. 1A, spaced apart from one another and positioned on the top surface 12, the first side surface 16, and the second side surface 18. Each slot 24 extends vertically along a portion of a height of each of the first side surface 16 and the second side surface 18 from the top surface 12 downward. Each slot 24 also extends along the top surface 12 across its width from the first side surface 16 to the second side surface 18. Each slot 24 is an indentation or a groove that has a generally rectangular or square cross-sectional shape, with first, second, and third surfaces. The first and second surfaces and the second and third surfaces are generally orthogonal to one another, and the first and third surfaces are generally parallel to one another. Exemplary embodiments of the slot 24 have a depth of approximately 0.01 inches and a width of approximately 0.05 inches, with a spacing between adjacent slots 24 of approximately 0.05 inches. In other embodiments, each slot 24 may have another geometrical shape, such as semi circular, semi oval, triangular, and the like.

In other embodiments, the slots 24 may be oriented in other directions. For example, as shown in FIGS. 1B, 1C, and 1D, the slots 24 may be arranged or oriented in a horizontal fashion along the first side surface 16 and the second side surface 18, and may extend from the first end surface 20 to the second end surface 22 along the top surface 12, the first side surface 16, and the second side surface 18. As another example shown in FIG. 1E, the slots 24 may be oriented in a diagonal fashion along the top surface 12, the first side surface 16, and the second side surface 18.

In addition, the slots 24 may be arranged on the glass slumping fixture 10 in groups, wherein each group of slots 24 forms a glass mold 26. In exemplary embodiments, each glass mold 26 may include ten (10) slots 24. Furthermore, the glass slumping fixture 10 may include a plurality of mold separators 28 that are positioned on the top surface 12. Each adjacent pair of mold separators 28 help to orient the glass sheet 100 positioned therebetween to be square with respect to the glass slumping fixture 10. That is, with a glass sheet 100 properly positioned between two adjacent mold separators 28, the lengthwise edges of the glass sheet 100 should form a roughly 90-degree angle with the side edges of the top surface 12. A first mold separator 28 is positioned adjacent to the first end surface 20, a second mold separator 28 is positioned adjacent to the second end surface 22, and each of the remaining mold separators 28 is positioned between successive adjacent pairs of glass molds 26. Exemplary embodiments of the glass slumping fixture 10 include five (5) glass molds 26 and six (6) mold separators 28.

Each glass mold 26 is configured to receive one glass sheet 100 and form one glass part 102. The slots 24 of each glass mold 26 allow for air to flow between the glass sheet 100 and the glass slumping fixture 10 while the glass sheet 100 is heated and the glass part 102 is being formed. A width of each glass mold 26 varies according to, or is determined by, a width of the glass sheet 100 and the glass part 102. The glass slumping fixture 10 can be utilized to form or create a plurality of roughly orthogonal folds or bends in the glass part 102. A width of the top surface 12 of the glass slumping fixture 10 varies according to, or is determined by, a distance between the two folds of the glass part 102.

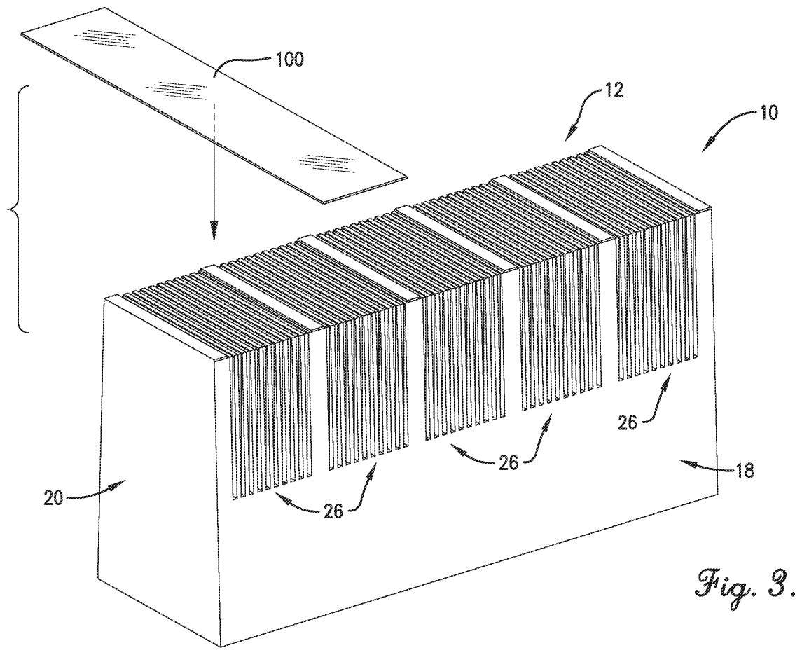

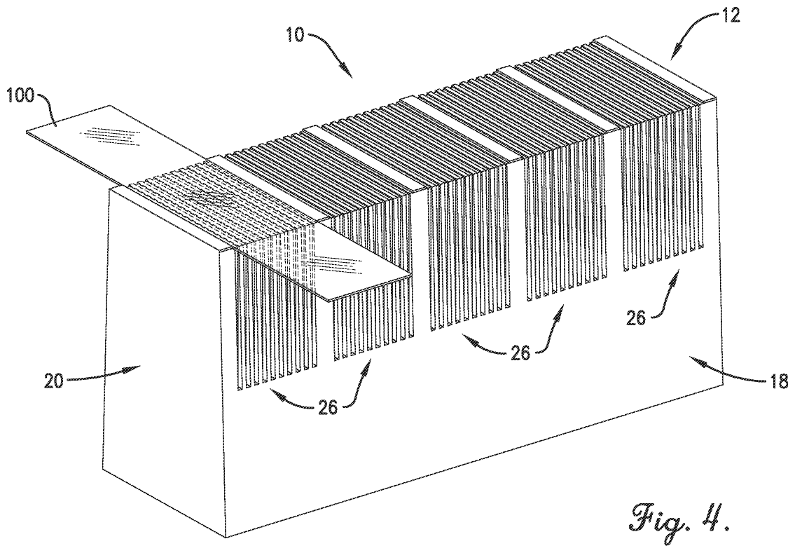

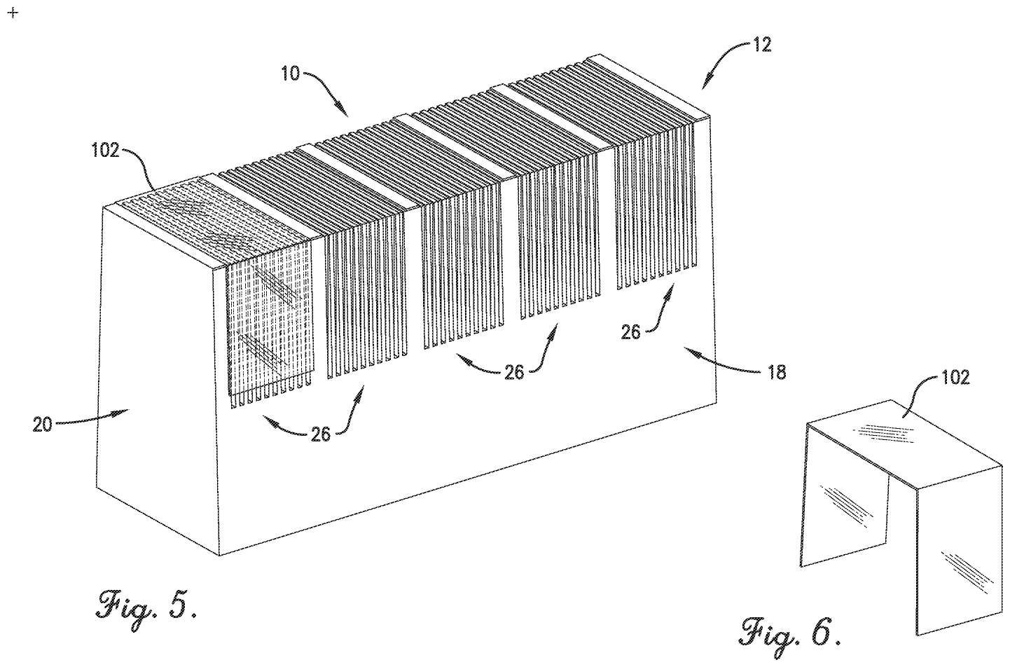

The glass slumping fixture 10 may be utilized for a glass slumping process as follows. The glass slumping fixture 10 may be positioned in a kiln or oven or may be placed on a free standing surface configured to allow the glass slumping fixture 10 to receive thermal energy. In certain embodiments, at least a portion of each of the top surface 12, the first side surface 16, and the second side surface 18 are coated with a mold release such as boron nitride, film, or other non-stick material. One or more glass sheets 100 are placed on the glass molds 26, over the slots 24—one glass sheet 100 for each glass mold 26, as shown in FIGS. 3 and 4. The glass sheets 100 are placed such that the desired locations for the folds in the glass part 102 to be formed are aligned with the edges of the top surface 12 of the glass slumping fixture 10. Thermal energy is applied to the glass sheets 100 to raise their temperature until they start to soften, deform, or slump. The glass sheets 100 are held at that temperature until the opposing ends of the glass sheets 100 slump or fall into contact with the first side surface 16 and the second side surface 18, as shown in FIG. 5. The slots 24 allow for air to flow between a lower surface of the glass sheet 100 and the first side surface 16, the second side surface 18, and the top surface 12 in each glass mold 26. The air flow along the slots 24 allows air to vent or escape, which would have otherwise been trapped under the glass sheet 100 and prevented the outer edges of the glass sheets 100 from fully contacting the first side surface 16 and the second side surface 18—leading to rounded folds in the glass part 102. After a period of time, thermal energy is reduced from the glass sheets 100 to allow the glass sheets 100 to cool and form the glass parts 102. The glass part 102, as shown in FIG. 6, is then removed from the glass slumping fixture 10.

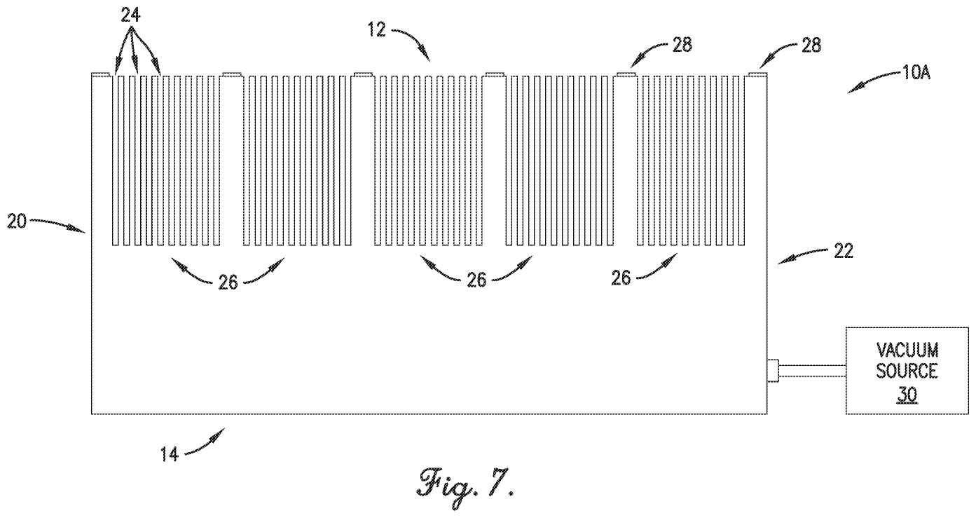

A glass slumping fixture 10A, which is a variation or alternative to the glass slumping fixture 10, is shown in FIG. 7. The glass slumping fixture 10A may be utilized to form glass parts 102 with more well-defined folds. That is, the angle of the fold between any two adjacent sections is approximately 90 degrees within a small tolerance. For example, while the angle of the fold for the glass slumping fixture 10 may be approximately 90 degrees with a tolerance of ±2 degrees, the tolerance of the fold angle for the glass slumping fixture 10A is ±1 degree. The glass slumping fixture 10A is similar in structure to the glass slumping fixture 10, except that the glass slumping fixture 10A is hollow and includes six walls connected to one another to form a box-type shape. An outer surface of each wall forms the surfaces 12, 14, 16, 18, 20, 22 discussed above. In addition, the slots 24 of the glass slumping fixture 10A form openings which extend through the walls of the first side surface 16, the second side surface 18, and the top surface 12, such that air can flow freely through the openings. Furthermore, the width of each slot 24, i.e., the size of each opening, ranges from approximately 0.03125 inches to approximately 0.0625 inches.

Accompanying the glass slumping fixture 10A is a vacuum source 30 which is fluidly coupled with the glass slumping fixture 10A. For example, the vacuum source 30 may include a hose which is connected to a port (or opening with a connector or fitting) on one of the walls that forms the first side surface 16, the second side surface 18, the first end surface 20, or the second end surface 22. The vacuum source 30 is configured to apply a vacuum, a suction, or negative pressure to the interior of the glass slumping fixture 10A.

The glass slumping fixture 10A may be utilized for a glass slumping process as follows. The glass slumping fixture 10A may be positioned in a kiln or oven or may be placed on a free standing surface configured to allow the glass slumping fixture 10A to receive thermal energy. If a kiln or oven is used, then the vacuum source 30 may be placed outside of the kiln or oven. Either way, the vacuum source 30 is fluidly coupled to the glass slumping fixture 10A. In certain embodiments, at least a portion of each of the top surface 12, the first side surface 16, and the second side surface 18 are coated with a mold release such as boron nitride, film, or other non-stick material. One or more glass sheets 100 are placed on the glass molds 26, over the slots 24—one glass sheet 100 for each glass mold 26, similar to what is shown in FIGS. 3 and 4. If any of the glass molds 26 are not utilized, then covers are placed over the slots 24 of the unused glass molds 26. The glass sheets 100 are placed such that the desired locations for the folds in the glass part 102 to be formed are aligned with the edges of the top surface 12 of the glass slumping fixture 10A. Thermal energy is applied to the glass sheets 100 to raise their temperature until they start to soften, deform, or slump. Vacuum from the vacuum source 30 may be applied at this time or just before. The glass sheets 100 are held at that temperature until the opposing ends of the glass sheets 100 slump or fall into contact with the first side surface 16 and the second side surface 18, similar to what is shown in FIG. 5. As the glass sheets 100 contact the first side surface 16 and the second side surface 18, vacuum flowing through the slots 24 tends to pull the opposing ends of the glass sheets 100 more tightly against the first side surface 16 and the second side surface 18—thereby creating glass parts 102 with folds that have a very small radius of curvature. After a period of time, thermal energy is reduced from the glass sheets 100 to allow the glass sheets 100 to cool and form the glass parts 102. The glass part 102, as shown in FIG. 6, is then removed from the glass slumping fixture 10A.

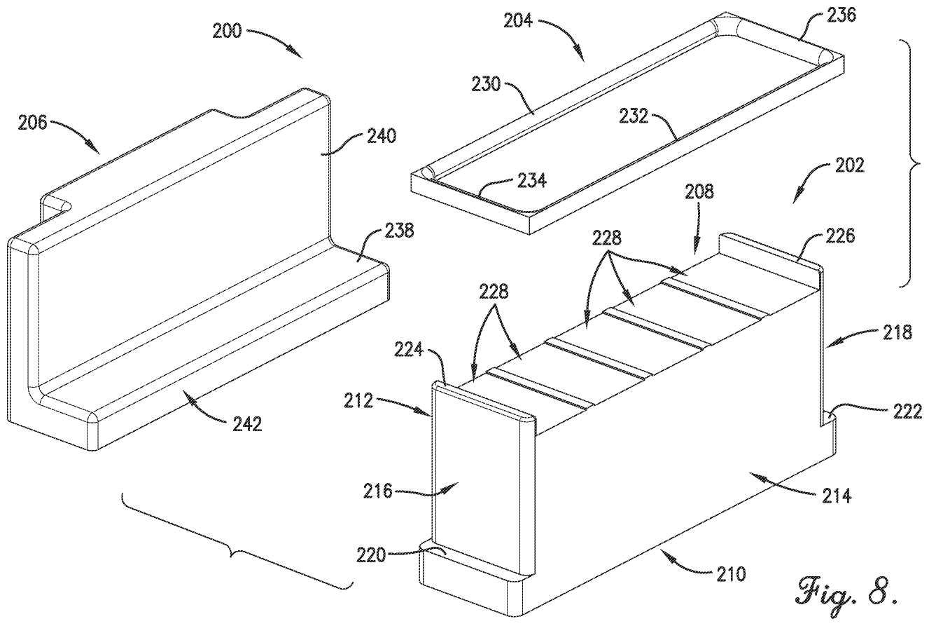

A glass slumping apparatus 200, constructed in accordance with at least a second embodiment of the current invention, is shown in FIGS. 8-11. The glass slumping apparatus 200 is also utilized to form the glass sheet 100 into the glass part 102, shown in FIG. 6, having one or more roughly orthogonal angles.

The glass slumping apparatus 200 broadly comprises a glass slumping fixture 202, a slumping weight 204, and a glass positioning fixture 206. The glass slumping fixture 202 includes a top surface 208, a bottom surface 210, a first side surface 212, a second side surface 214, a first side surface 216, a second end surface 218, a first pedestal 220, a second pedestal 222, a first end wall 224, and a second end wall 226. The listed surfaces are connected to one another appropriately to form a generally rectangular box shape. In some embodiments, the glass slumping fixture 202 is generally solid. In other embodiments, the glass slumping fixture 202 may include a cavity or may be hollow, such that the glass slumping fixture 202 includes six walls, an outer surface of each forming the previously-listed surfaces. Each surface may connect to its adjacent surfaces with an interior angle that is generally orthogonal or 90 degrees. The four edges between the first side surface 212, the second side surface 214, the first side surface 216, and the second end surface 218 are each rounded or “bullnosed”.

The first pedestal 220 extends outward from a lower edge of the first side surface 216, and the second pedestal 222 extends outward from a lower edge of the second end surface 218. The first end wall 224 extends upward from the top surface 208 at the first side surface 216, and the second end wall 226 extends upward from the top surface 208 at the second end surface 218. The side edges of the first end wall 224 and the second end wall 226 are each rounded or “bullnosed”.

Referring to FIGS. 8-11, the glass slumping fixture 202 further includes a plurality of glass molds 228 spaced apart from one another and positioned on the top surface 208. Each glass mold 228 extends on the top surface 208 across its width from the first side surface 212 to the second side surface 214. Each glass mold 228 is a channel that has a generally rectangular or square cross-sectional shape, with first, second, and third surfaces. The depth of the channel of each glass mold 228 varies according to, or is determined by, a thickness of the glass sheet 100. Exemplary embodiments of the glass slumping fixture 202 include five (5) glass molds 228. Each glass mold 228 is configured to receive one glass sheet 100 and form one glass part 102.

The glass slumping fixture 202 is typically formed from material that can withstand the temperature required to melt the glass sheets 100, such that the glass slumping fixture 202 will not deform or melt while the glass part 102 is being formed. In addition, it is desirable that the material of the glass slumping fixture 202 have a coefficient of thermal expansion (CTE) that is similar to a CTE of the glass sheets 100. Exemplary materials for the glass slumping fixture 202 include ceramics.

The slumping weight 204 has a first side wall 230, a second side wall 232, a first end wall 234, and a second end wall 236 which are connected to one another appropriately to have a generally rectangular shape with a hollow interior. Furthermore, each interior corner is rounded having a radius of curvature that is slightly larger than a radius of curvature of the edges between the side surfaces and the end surfaces of the glass slumping fixture 202 of the glass slumping fixture 202. In addition, the dimensions of the interior of the slumping weight 204 are slightly larger than the dimensions of the corresponding exterior of the glass slumping fixture 202. That is, a distance between the inner surfaces of the side walls 230, 232 of the slumping weight 204 is slightly larger than a distance between the side surfaces 212, 214 of the glass slumping fixture 202. And, a distance between the inner surfaces of the end walls 234, 236 of the slumping weight 204 is slightly larger than a distance between the end surfaces 216, 218 of the glass slumping fixture 202. In other words, an inner perimeter of the slumping weight 204 is slightly larger than an outer perimeter of the glass slumping fixture 202.

The slumping weight 204 is utilized during a slumping process to provide a weight or mass, which provides downward force on the one or more glass sheets 100 while they are heated and start to deform. The weight or mass of the slumping weight 204 varies according to, or is determined by, a number of glass sheets 100 to form, a thickness of the glass sheets 100, a viscosity of the glass sheets 100, or combinations thereof. There is typically a positive correlation between the number of glass sheets 100 to form and the weight of the slumping weight 204. For example, a larger number of glass sheets 100 requires a greater weight of the slumping weight 204. A smaller number of glass sheets 100 requires less weight of the slumping weight 204, relative to the weight required for the larger number of glass sheets 100. There is typically a positive correlation between the thickness of glass sheets 100 to form and the weight of the slumping weight 204. For example, glass sheets 100 that are thicker require a greater weight of the slumping weight 204. Glass sheets 100 that are thinner require less weight of the slumping weight 204, relative to the weight required for the thicker glass sheets 100. There is typically a positive correlation between the viscosity of glass sheets 100 to form and the weight of the slumping weight 204. For example, glass sheets 100 that have a higher viscosity require a greater weight of the slumping weight 204. Glass sheets 100 that have a lower viscosity require less weight of the slumping weight 204, relative to the weight required for the harder glass sheets 100.

The slumping weight 204 may be formed from the same material as the glass slumping fixture 202 or, at least, material with an approximately equivalent CTE as the glass slumping fixture 202. In order to vary the weight of the slumping weight 204, a height of each wall 230, 232, 234, 236 may be varied or a thickness (or width) of each wall 230, 232, 234, 236 may be varied as long as the inner dimensions of the slumping weight 204 are maintained as discussed above. Alternatively, in order to vary the weight of the slumping weight 204, a plurality of smaller, fixed weight slumping weights 204 may be utilized with the number of slumping weights 204 being varied in order to provide the approximate weight that is required. For example, if a single slumping weight 204 weighs 0.5 pounds and a weight of 1.5 pounds is required for forming the glass part 102, then three (3) slumping weights 204 may be utilized.

The glass positioning fixture 206 is configured to position the glass sheets 100 on the glass slumping fixture 202 if a certain position of the folds in the glass part 102 is desired. The glass positioning fixture 206 includes a base 238 and a vertical wall 240. The base 238 may be of generally rectangular box shape or other suitable shape that includes a contact surface 242 that is generally planar and generally vertically oriented. The vertical wall 240 extends upward from the base 238 at a first horizontal distance along an upper surface of the base 238 from the contact surface 242. The first horizontal distance may be adjusted according to the position of one or both of the folds along a length of the glass sheet 100. A height of the vertical wall 240 is greater than a height of the glass slumping fixture 202 of the glass slumping fixture 202 from the bottom surface 210 to the top surface 208. The glass positioning fixture 206 may be optional if the position of one or both of the folds along the length of the glass sheet 100 is not critical.

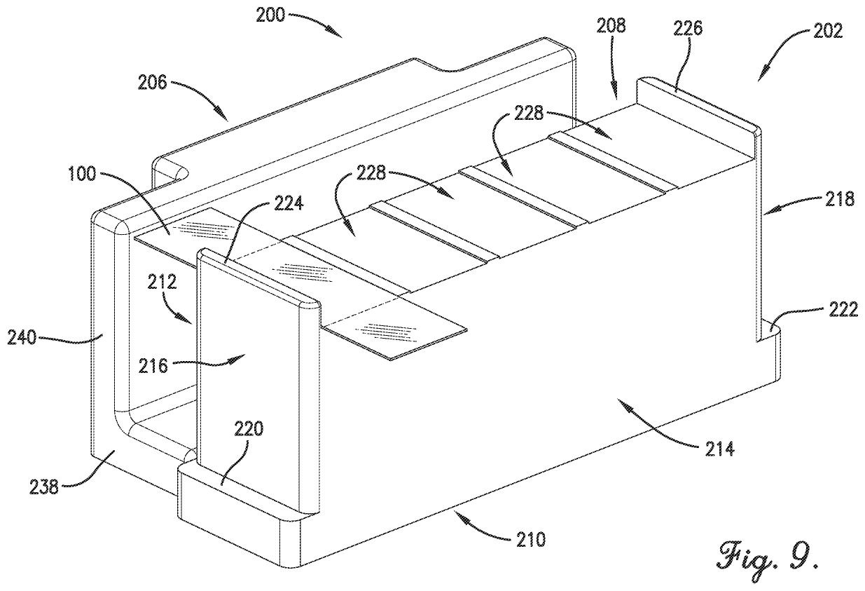

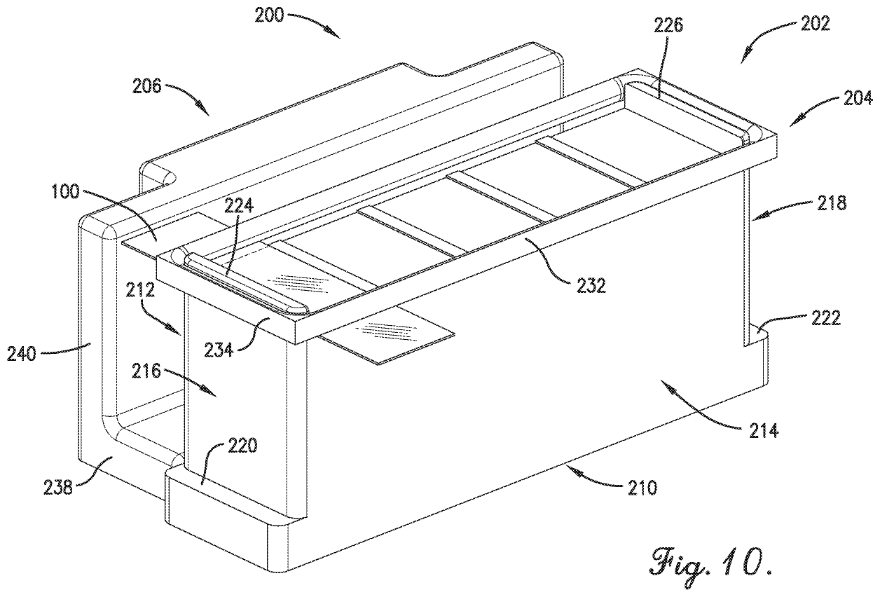

The glass slumping apparatus 200 may be utilized for the glass slumping process as follows. The glass slumping fixture 202 may be positioned in a kiln or oven or may be placed on a free standing surface. In certain embodiments, at least a portion of each of the top surface 208, the first side surface 212, and the second side surface 214 are coated with a mold release such as boron nitride, film, or other non-stick material. If needed, the glass positioning fixture 206 is placed beside the glass slumping fixture 202, such that the contact surface 242 touches a lower portion of either the first side surface 212 or the second side surface 214. One or more glass sheets 100 are placed on the glass molds 228—one glass sheet 100 for each glass mold 228, as shown in FIG. 9. The glass sheets 100 are placed such that one of the end edges of each glass sheet 100 contacts the vertical wall 240. Alternatively, the glass sheets 100 are placed such that the desired locations for the folds in the glass part 102 to be formed are aligned with the edges of the top surface 208 of the glass slumping fixture 202. Referring to FIG. 10, the slumping weight 204 is positioned on the upper surface of the one or more glass sheets 100 such that the first and second end walls 234, 236 of the slumping weight 204 wrap around the first and second end walls 224, 226, respectively, of the glass slumping fixture 202. If it was used, the glass positioning fixture 206 is removed. Thermal energy is applied to the glass sheets 100 to raise their temperature until they start to soften, deform, or slump. The slumping weight 204 applies downward pressure to the one or more glass sheets 100, and as the glass sheets 100 slump, the slumping weight 204 slides downward and presses the opposing sides of the one or more glass sheets 100 onto the first side surface 212 and the second side surface 214 of the glass slumping fixture 202. Referring to FIG. 11, as the one or more glass sheets 100 slump completely, the slumping weight 204 slides down to the first pedestal 220 and the second pedestal 222 of the glass slumping fixture 202. After a period of time, thermal energy is reduced from the glass sheets 100 to allow the glass sheets 100 to cool and form the glass parts 102. The glass part 102, as shown in FIG. 6, is then removed from the glass slumping fixture 202. The weight of the slumping weight 204 applying pressure on the opposing sides of the one or more glass sheets 100 onto the first side surface 212 and the second side surface 214 of the glass slumping fixture 202 creates well-defined edges at the folds of the glass part 102.

In certain embodiments, the slumping process may be a two-stage process which utilizes the glass slumping fixture 10 and the glass slumping fixture 202. One or more glass sheets 100 are slumped to form glass parts 102 with near 90-degree folds using the glass slumping fixture 10, as described above. The glass parts 102 are then positioned on the glass slumping fixture 202, with each glass part 102 being positioned on a successive one of the glass molds 228. The slumping weight 204 is placed on the glass parts 102 and the slumping process utilizing the glass slumping fixture 202 described above is performed.

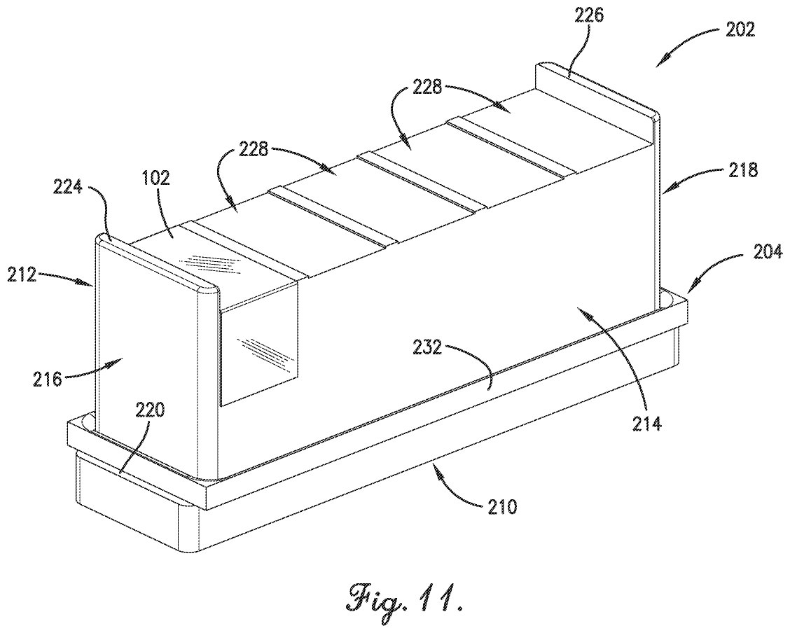

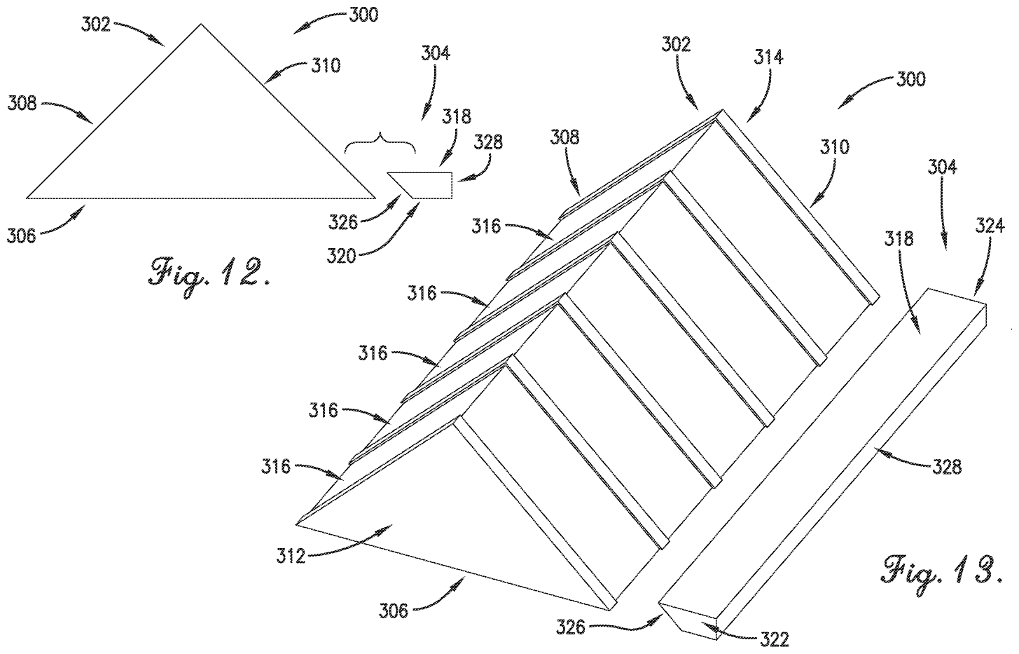

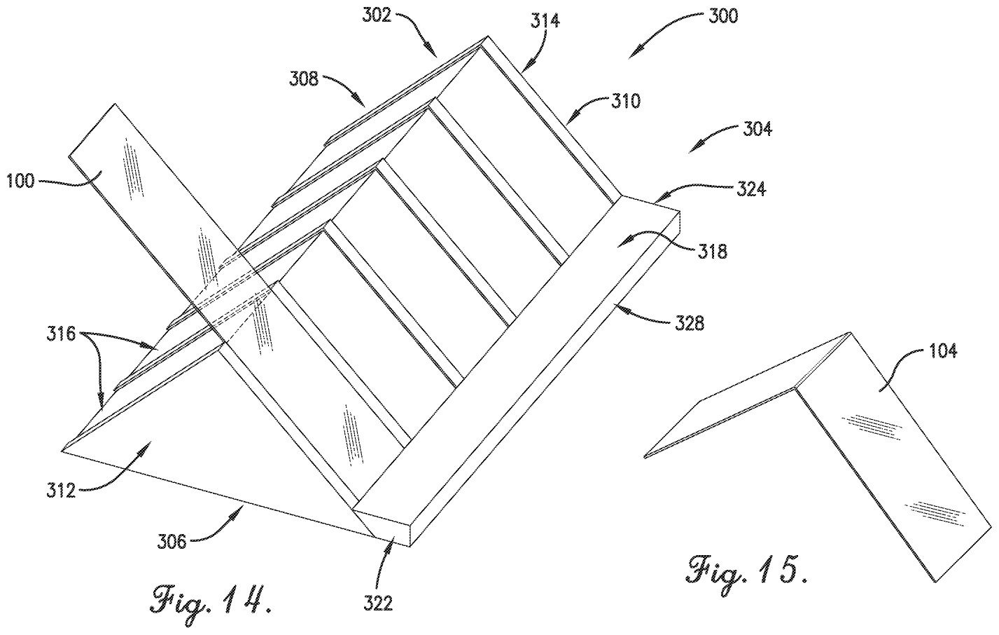

A glass slumping apparatus 300, constructed in accordance with at least a third embodiment of the current invention, is shown in FIGS. 12-14. The glass slumping apparatus 300 is utilized to form a glass sheet 100 into a glass part 104, shown in FIG. 15, having a single roughly orthogonal angle.

The glass slumping apparatus 300 broadly comprises a glass slumping fixture 302 and a glass holding fixture 304. The glass slumping fixture 302 has a generally isosceles triangular cross-sectional shape with a bottom surface 306, a first angled surface 308, a second angled surface 310, a first end surface 312, and a second end surface 314. In some embodiments, the glass slumping fixture 302 is generally solid. In other embodiments, the glass slumping fixture 302 may include a cavity or may be hollow, such that the glass slumping fixture 302 includes five walls, an outer surface of each forming the previously-listed surfaces. The first angled surface 308 and the second angled surface 310 are connected to one another to form an edge with a roughly 90-degree interior angle, although the first angled surface 308 and the second angled surface 310 could be connected to one another to form an edge with an interior angle having a value between 0 and 180 degrees. In some embodiments, the edge between the first angled surface 308 and the second angled surface 310 has zero radius of curvature. In other embodiments, the edge between the first angled surface 308 and the second angled surface 310 has a radius of curvature that is greater than zero.

Referring to FIGS. 13 and 14, the glass slumping fixture 302 further includes a plurality of glass molds 316 spaced apart from one another and positioned on the first angled surface 308 and the second angled surface 310. Each glass mold 316 extends from the bottom surface 306 on the first angled surface 308 and the second angled surface 310 to the apex where the surfaces 308, 310 meet. Each glass mold 316 is a channel that has a generally rectangular or square cross-sectional shape, with first, second, and third surfaces. The depth of the channel of each glass mold 316 varies according to, or is determined by, a thickness of the glass sheet 100. Exemplary embodiments of the glass slumping fixture 302 include five (5) glass molds 316. Each glass mold 316 is configured to receive one glass sheet 100 and form one glass part 104.

The glass slumping fixture 302 is typically formed from material that can withstand the temperature required to melt the glass sheets 100, such that the glass slumping fixture 302 will not deform or melt while the glass part 104 is being formed. In addition, it is desirable that the material of the glass slumping fixture 302 have a coefficient of thermal expansion (CTE) that is similar to, or less than, a CTE of the glass sheets 100. Exemplary materials for the glass slumping fixture 302 include ceramics.

The glass holding fixture 304 includes a top surface 318, a bottom surface 320, a first end surface 322, a second end surface 324, a first side surface 326, and a second side surface 328. The glass holding fixture 304 has a generally rectangular box shape, except that the first side surface 326 is oriented between the top surface 318 and the bottom surface 320 at an angle that is supplementary to an angle between either one of the angled surfaces 308, 310 and the bottom surface 306 of the glass slumping fixture 302. The glass holding fixture 304 has a length that is roughly equivalent to a length of the glass slumping fixture 302. The glass holding fixture 304 is typically formed from material that is the same as, or has a roughly equivalent CTE as, the material of the glass slumping fixture 302.

The glass slumping apparatus 300 may be utilized for a glass slumping process as follows. The glass slumping fixture 302 may be positioned in a kiln or oven or may be placed on a free standing surface. In certain embodiments, at least a portion of each of the first angled surface 308 and the second angled surface 310 are coated with a mold release such as boron nitride, film, or other non-stick material. One or more glass sheets 100 are placed on the glass molds 316 such that each glass sheet 100 is placed on the first angled surface 308 or the second angled surface 310—one glass sheet 100 for each glass mold 316, as shown in FIG. 14. The glass holding fixture 304 is positioned adjacent to the first angled surface 308 or the second angled surface 310 and in contact with the lower edges of the glass sheets 100, so as to hold the glass sheets 100 in place. Thermal energy is applied to the glass sheets 100 to raise their temperature until they start to soften, deform, or slump. The glass sheets 100 are held at that temperature until the free ends of the glass sheets 100 slump or fall into contact with the opposing angled surface 308, 310. After a period of time, thermal energy is reduced from the glass sheets 100 to allow the glass sheets 100 to cool and form the glass parts 104. The glass part 104, as shown in FIG. 15, is then removed from the glass slumping fixture 302.

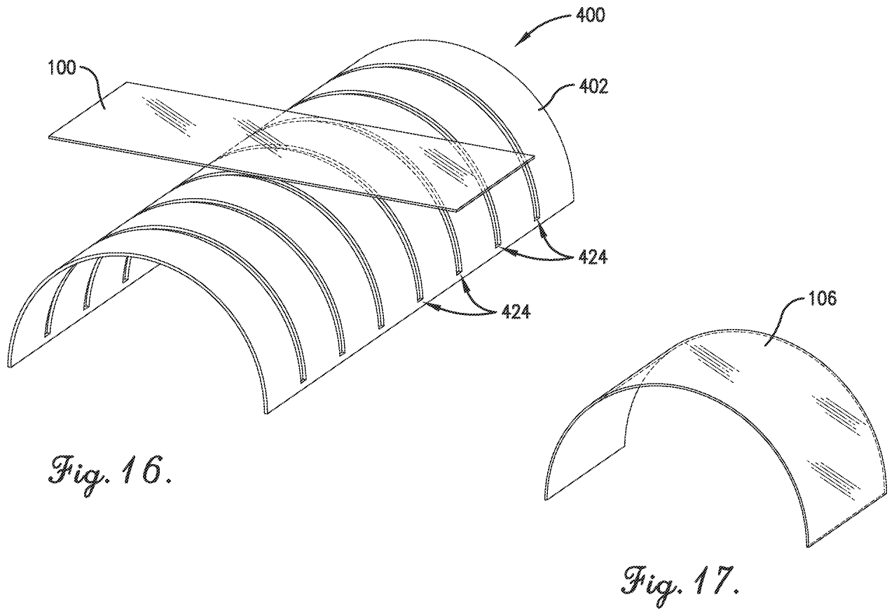

A glass slumping fixture 400, constructed in accordance with at least a fourth embodiment of the current invention, is shown in FIG. 16. The glass slumping fixture 400 is utilized to form a glass sheet 100 into a glass part 106, shown in FIG. 17, having a curvature along at least one axis to create an arcuate shape in the part 106. The glass slumping fixture 400 includes an upper surface 402 that has a curvature along at least one axis, wherein a radius of curvature may be selectively adjusted. Exemplary embodiments of the upper surface 402 may have a partial cylindrical shape, although other rounded shapes may be possible, such as a saddle shape, which has a curvature along two axes. In addition, the upper surface 402 may include contours or other features of interest. In some embodiments, the upper surface 402 may be formed by one or more walls, such as a circumferential side wall of a portion of a cylinder, wherein the wall includes a lower surface as well. In other embodiments, the upper surface 402 may be formed by a partially cylindrical body that is generally solid.

The glass slumping fixture 400 further includes a plurality of slots 424 spaced apart from one another and positioned on the upper surface 402. If the upper surface 402 is formed by a side wall, then each slot 424 extends through the wall from the upper surface 402 to the lower surface. If the upper surface 402 is formed by a partially cylindrical body, then each slot 424 is an indentation or a groove into the surface 402 that has a generally rectangular or square cross-sectional shape, with first, second, and third surfaces. The first and second surfaces and the second and third surfaces are generally orthogonal to one another, and the first and third surfaces are generally parallel to one another. Exemplary embodiments of the slot 424 have a depth of approximately 0.01 inches and a width of approximately 0.05 inches, with a spacing between adjacent slots 424 of approximately 0.05 inches. In other embodiments, each slot 424 may have another geometrical shape, such as semi circular, semi oval, triangular, and the like.

The glass slumping fixture 400 may be utilized for a glass slumping process as follows. The glass slumping fixture 400 may be positioned in a kiln or oven or may be placed on a free standing surface configured to allow the glass slumping fixture 400 to receive thermal energy. In certain embodiments, at least a portion of the upper surface 402 is coated with a mold release such as boron nitride, film, or other non-stick material. One or more glass sheets 100 are placed on the upper surface 402, over the slots 424. Thermal energy is applied to the glass sheets 100 to raise their temperature until they start to soften, deform, or slump. The glass sheets 100 are held at that temperature until the opposing ends of the glass sheets 100 slump or fall into contact with the upper surface 402. The slots 424 allow for air to flow between a lower surface of the glass sheet 100 and the upper surface 402. The air flow through or along the slots 424 allows air to vent or escape, which would have otherwise been trapped under the glass sheet 100 and prevented the outer edges of the glass sheets 100 from fully contacting the upper surface 402. After a period of time, thermal energy is reduced from the glass sheets 100 to allow the glass sheets 100 to cool and form the glass parts 106. The glass part 106, as shown in FIG. 17, is then removed from the glass slumping fixture 400.

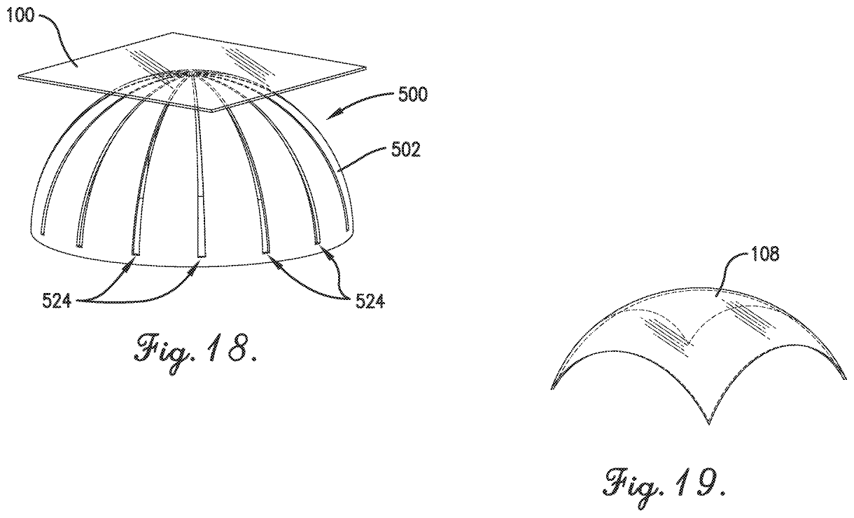

A glass slumping fixture 500, constructed in accordance with at least a fifth embodiment of the current invention, is shown in FIG. 18. The glass slumping fixture 500 is utilized to form a glass sheet 100 into a glass part 108, shown in FIG. 19, having a generally rounded shape, such as a dome or hemispheric shape. The glass slumping fixture 500 includes an upper, or outer, surface 502 that has a generally rounded shape, such as a dome or hemispheric shape. The upper surface 502 may also include contours or other features of interest. Exemplary embodiments of the upper surface 502 have a hemispheric shape, wherein the radius of curvature is selectively adjustable. In some embodiments, the upper surface 502 may be formed by one or more walls, such as a portion of a hemispheric shell, wherein the wall includes a lower, or inner, surface as well. In other embodiments, the upper surface 502 may be formed by a partially hemispheric body that is generally solid.

The glass slumping fixture 500 further includes a plurality of slots 524 distributed along the upper surface 502. At least a portion of each slot 524 is spaced apart from the other slots 524. In some embodiments, at least a portion of the slots 524 intersect at least one other slot 524. For example, the slots 524 may be oriented on the upper surface 502 in the form of global lines of longitude. In other embodiments, the slots 524 may be generally parallel to one another. For example, the slots 524 may be oriented on the upper surface 502 in the form of global lines of latitude. If the upper surface 502 is formed by a wall or shell, then each slot 524 extends through the wall from the upper surface 502 to the lower surface. If the upper surface 502 is formed by a partially hemispheric body, then each slot 524 is an indentation or a groove into the surface 502 that has a generally rectangular or square cross-sectional shape, with first, second, and third surfaces.

The glass slumping fixture 500 may be utilized for a glass slumping process as follows. The glass slumping fixture 500 may be positioned in a kiln or oven or may be placed on a free standing surface configured to allow the glass slumping fixture 500 to receive thermal energy. In certain embodiments, at least a portion of the upper surface 502 is coated with a mold release such as boron nitride, film, or other non-stick material. One glass sheet 100 is placed on the upper surface 502, over the slots 524. Thermal energy is applied to the glass sheets 100 to raise their temperature until they start to soften, deform, or slump. The glass sheets 100 are held at that temperature until the corners and/or the opposing ends of the glass sheets 100 slump or fall into contact with the upper surface 502. The slots 524 allow for air to flow between a lower surface of the glass sheet 100 and the upper surface 502. The air flow through or along the slots 524 allows air to vent or escape, which would have otherwise been trapped under the glass sheet 100 and prevented the corners and outer edges of the glass sheets 100 from fully contacting the upper surface 502. After a period of time, thermal energy is reduced from the glass sheet 100 to allow the glass sheet 100 to cool and form the glass parts 108. The glass part 108, as shown in FIG. 19, is then removed from the glass slumping fixture 500.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112 (f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A glass slumping fixture comprising:
a structure including a first side surface, a spaced-apart second side surface, and a top surface positioned therebetween and connected to each side surface, the structure further including a plurality of slots spaced apart from one another and positioned on the first side surface, the second side surface, and the top surface, each slot being an indentation that extends below the surface on which it is positioned,
wherein the structure is configured to retain a glass sheet during a slumping process including the glass sheet being placed on the top surface over the slots and heated until a first portion of the glass sheet contacts the first side surface and a second portion of the glass sheet contacts the second side surface.

2. The glass slumping fixture of claim 1, wherein each slot extends vertically along at least a portion of a height of the first side surface, vertically along at least a portion of a height of the second side surface, and across the top surface from the first side surface to the second side surface.

3. The glass slumping fixture of claim 1, wherein
the structure further includes a first end surface and a spaced-apart second end surface, each connected to end edges of the first side surface, the second side surface, and the top surface, and
the slots extend from the first end surface to the second end surface along the top surface, the first side surface, and the second side surface.

4. The glass slumping fixture of claim 1, wherein each slot has a generally rectangular cross-sectional shape with generally orthogonal first, second, and third surfaces.

5. The glass slumping fixture of claim 1, wherein the slots are divided into a plurality of groups of slots with a space between adjacent groups such that the structure is configured to receive a plurality of glass sheets, with each glass sheet being placed on the top surface over a successive one of the groups of slots and heated until a first portion of the glass sheet contacts the first side surface and a second portion of the glass sheet contacts the second side surface.

6. The glass slumping fixture of claim 1, wherein the top surface is connected to each of the first side surface and the second side surface with an interior angle that is approximately 90 degrees.

7. The glass slumping fixture of claim 1, wherein the top surface is connected to each of the first side surface and the second side surface with an interior angle that is greater than 90 degrees.

8. A glass slumping apparatus comprising:
a glass slumping fixture configured to retain a glass sheet during a slumping process, the glass slumping fixture including
a first side surface, a spaced-apart second side surface, and a top surface positioned therebetween and connected to each side surface, the top surface configured to receive the glass sheet,
a first end wall connected to a first end of the top surface, and
a second end wall connected to a second end of the top surface, the first end wall and the second end wall each extending above the top surface; and
a slumping weight including a first side wall, a second side wall, a first end wall, and a second end wall connected to one another to form a rectangular weight with an open center, the slumping weight configured to be positioned on the glass sheet at the start of the slumping process and around a lower end of the glass slumping fixture at the end of the slumping process.

9. The glass slumping apparatus of claim 8, wherein the glass slumping fixture further includes
a first end surface connected to a first end of the first side surface and the second side surface,
a second end surface connected to a second end of the first side surface and the second side surface,
a first pedestal extending outward from a lower edge of the first end surface, and
a second pedestal extending outward from a lower edge of the second end surface,
wherein the slumping weight is positioned on the first pedestal and the second pedestal at the end of the slumping process.

10. The glass slumping apparatus of claim 9, wherein each of the edges between the first side surface, the second side surface, the first end surface, and the second end surface are rounded.

11. The glass slumping apparatus of claim 8, wherein each of the four interior corners of the slumping weight is rounded.

12. The glass slumping apparatus of claim 8, wherein the two outer edges of the first end wall and the two outer edges of the second end wall of the glass slumping fixture are each rounded.

13. The glass slumping apparatus of claim 8, wherein a dimension between inner side surfaces of the slumping weight is larger than a dimension between outer side surfaces of the glass slumping fixture, and a dimension between inner end surfaces of the slumping weight is larger than a dimension between outer end surfaces of the glass slumping fixture.

14. The glass slumping apparatus of claim 8, wherein the top surface of the glass slumping fixture is connected to each of the first side surface and the second side surface of the glass slumping fixture with an interior angle that is approximately 90 degrees.

15. The glass slumping apparatus of claim 8, wherein the slumping weight is formed from material that has a coefficient of thermal expansion which is approximately equal to a coefficient of thermal expansion of a material used to form the glass slumping fixture.

16. The glass slumping apparatus of claim 8, further comprising a glass positioning fixture including
a base having a contact surface that is generally planar and generally vertically oriented, the contact surface configured to contact a lower edge of one of the side surfaces of the glass slumping fixture, and
a vertical wall extending upward from the base and having a first horizontal distance from the contact surface, the first horizontal distance varying according to a relative position of at least one fold along a length of the glass sheet.

17. A glass slumping apparatus comprising:
a glass slumping fixture configured to retain a glass sheet during a slumping process, the glass slumping fixture including
a bottom surface, a first angled surface, and a second angled surface connected to one another to form a triangle cross section, one of the angled surfaces configured to receive the glass sheet, and
a first end surface and a spaced apart second end surface each connected to an opposing end of the bottom surface, the first angled surface, and the second angled surface; and
a glass holding fixture including a multi-surface structure having a length roughly equivalent to a length of the glass slumping fixture, the glass holding fixture configured to hold a portion of the glass sheet against one of the angled surfaces during the slumping process.

18. The glass slumping apparatus of claim 17, wherein the first angled surface and the second angled surface are connected to one another to form an edge having an internal angle of approximately 90 degrees.

19. The glass slumping apparatus of claim 17, wherein the glass holding fixture includes a top surface, a bottom surface, a first end surface, a second end surface, a first side surface, and a second side surface connected to one another to form a generally rectangular box shape, except that the first side surface is oriented between the top surface and the bottom surface at an angle that is supplementary to an angle between either one of the angled surfaces and the bottom surface of the glass slumping fixture.

20. The glass slumping apparatus of claim 17, wherein the glass holding fixture is formed from material that has a coefficient of thermal expansion which is approximately equal to a coefficient of thermal expansion of a material used to form the glass slumping fixture.
